(19) United States
(12) Patent Application Publication
(10) Pub. No.: US 2025/0325122 A1
(43) Pub. Date: Oct. 23, 2025

(54) PLANT CARE SYSTEMS

(71) Applicant: Michael Montaruli, Jefferson, MA (US)

(72) Inventor: Michael Montaruli, Jefferson, MA (US)

(21) Appl. No.: 19/182,894

(22) Filed: Apr. 18, 2025

Related U.S. Application Data
(60) Provisional application No. 63/636,189, filed on Apr. 19, 2024.

(51) Int. Cl. A47G 7/04; A01G 13/21

(52) U.S. Cl. CPC A47G 7/041; A01G 13/21

(57) ABSTRACT

The plant care system may be used for home plant cultivation, including plants and vegetation of many types. This purpose-built Lazy Susan table is meticulously designed for use in tents, providing plant growers with unparalleled convenience and precision. The plant care system transforms the way a plant grower can care for their plants by offering a 360-degree spin functionality, effortlessly bringing each plant in front of the gardener as desired for tending.

### CROSS-REFERENCE TO RELATED APPLICATION

The present application is related to and claims priority from prior provisional application Ser. No. 63/636,189, filed Apr. 19, 2024 which application is incorporated herein by reference.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of plants and more specifically relates to plant care.

### 2. DESCRIPTION OF THE RELATED ART

Many people grow plants for pleasure and others for producing income as a business. Plants may require different means of manipulation which may not be available on conventional shelves, tables, or on ground surfaces. A multi-purpose device that can help plant growers manipulate plants comfortably, as desired, is what is needed.

Various attempts have been made to solve the above-mentioned problems such as those found in Chinese Pat. No. CN215649730U. This art is representative of plant care. None of the above inventions and patents, taken either singly or in combination, is seen to describe the invention as claimed.

Ideally, a plant care device should provide owners of plants with multiple ways to protect and promote plant growth and, yet would operate reliably and be manufactured at a modest expense. Thus, a need exists for a reliable plant care system to avoid the above-mentioned problems.

### BRIEF SUMMARY OF THE INVENTION

In view of the foregoing disadvantages inherent in the known plant care art, the present invention provides a novel plant care system, entitled herein as Lazy Susan table. The general purpose of the present invention, which will be described subsequently in greater detail is to provide a plant care system to promote plant growth and health.

The plant care system may be used for home plant cultivation, including plants and vegetation of many types. This purpose-built Lazy Susan table is meticulously designed for use in tents, providing plant growers with unparalleled convenience and precision. The plant care system transforms the way a plant grower can care for their plants by offering a 360-degree spin functionality, effortlessly being able to bring each plant in front of the gardener at the desired angle for tending.

In a preferred embodiment, as disclosed herein, the plant care system comprises: a plant care assembly including a lower table functioning as a base, the lower table having a lower-table-top-surface with at least one channel, a drainage channel, at least one leg, and at least one conduit port. The plant care assembly further comprises an upper table configured as a circular table having an upper-table-top-surface, a thickness, and an under-table-top-surface. The plant care assembly further comprises a coupler able to engage the lower table and the upper table in functional combination such that the upper table of the plant care assembly is able to rotate in relation to the lower table, the upper table located on a plane above the lower table during use. A pole may be used within the coupler.

The at least one leg of the lower table preferably comprises four of the legs, wherein the legs are adjustable in relation to a ground surface. The upper table comprises a grid of apertures, and an upper netting support, and the upper table comprises an upper netting. The upper netting allows light stem training as a canopy; wherein the upper netting comprises a net-lattice, and the net-lattice comprises a grid, wherein the grid comprises bars separating negative spaces, and the negative spaces allow light to pass through. The upper table preferably comprises netting supports, wherein the netting supports are adjustable between up and down positions in relation to the lower table. The thickness is defined between the upper-table-top-surface and the under-table-top-surface.

As defined and described herein the plant care system is configured for use to elevate at least one host plant and such that the upper table is able to be rotated in relation to the lower table such that the at least one host plant is able to be rotate-manipulated through 360 degrees to a desired positioning for tending the at least one host plant, and wherein branches of the at least one host plant are able to be supported in a stretched positioning via connection to the canopy.

The plant care system of the present invention may further comprise a kit including: the plant care assembly, and a set of user-instructions to facilitate use thereof.

A method of using a plant care system is also described herein comprising the steps of: providing the plant care system, setting at least one host plant on top of an upper table, and rotating the upper table in relation to a lower table to tend the at least one host plant in a desired positioning. The method may further comprise the step of supporting branches of the at least one host plant in a stretched positioning via connection to a canopy. Rotating and adjusting and other steps may be also employed.

The present invention holds significant improvements and serves as a plant care system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, plant care system, constructed and operative according to the teachings of the present invention.

FIG. 1 shows a front view illustrating a plant care system according to an embodiment of the present invention.

FIG. 2 is a perspective view illustrating the plant care system according to an embodiment of the present invention of FIG. 1.

FIG. 3 is a side view illustrating the plant care system according to an embodiment of the present invention of FIG. 1.

FIG. 4 is a perspective view illustrating the castors of the plant care system according to an embodiment of the present invention of FIG. 1.

FIG. 5 is a top view of the drawers of the plant care system according to an embodiment of the present invention.

FIG. 6 is a side view of the plant care system according to an embodiment of the present invention.

FIG. 7 is a side view of the circular table of the plant care system according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to plants and more particularly to plant cultivation as used to improve the performance of plant growth.

Generally speaking, the plant care system entitled LAZY JANE, may be used for home plant cultivation, including plants and vegetation of many types. This purpose-built Lazy Susan table is meticulously designed for use in tents, providing plant growers with unparalleled convenience and precision. The plant care system, LAZY JANE, transforms the way a plant grower can care for their plants by offering a 360-degree spin functionality, effortlessly bringing each plant in front of the gardener. There is no more stretching or reaching with the plant care system, LAZY JANE, every corner of your plant tent is within easy reach. The plant care system table's smooth rotation ensures a hassle-free gardening experience. The plant care system goes beyond convenience by featuring an integrated screen of green (“SCROG”) net option, allowing growers to achieve an even canopy of growth. This added feature empowers growers (user's) to optimize light distribution and promote uniform plant development. There is no more concern about your plant being locked in place as the plant tender reaches through the netting. The user just gives the plant care system table a spin and the plant can be reached from all sides. Crafted with durability in mind, the present invention is the perfect companion for growers of all levels. As designed, it elevates the growers' cultivation game, streamline the workflow, and effectively ensuring plants receive the care they deserve.

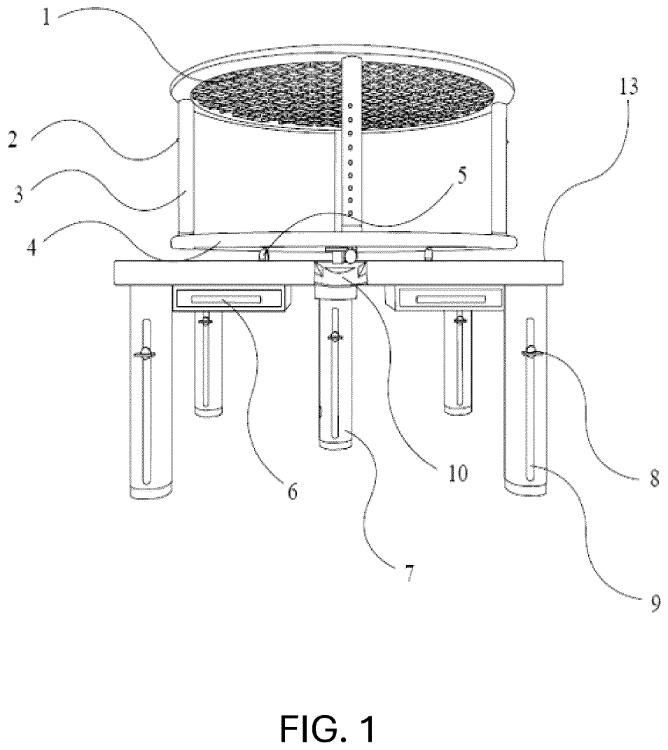

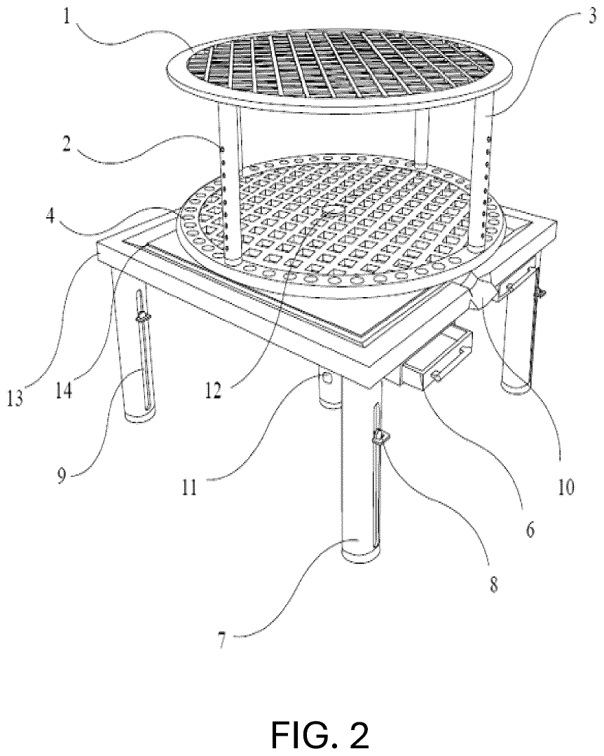

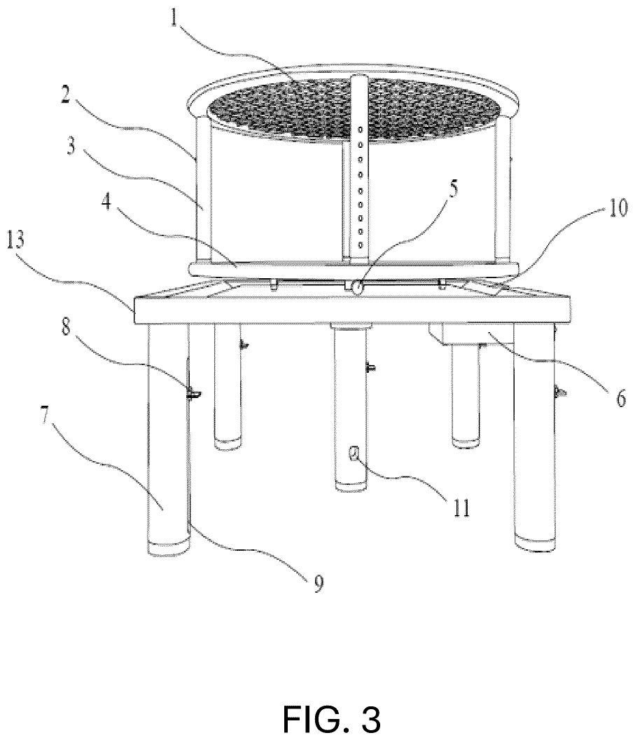

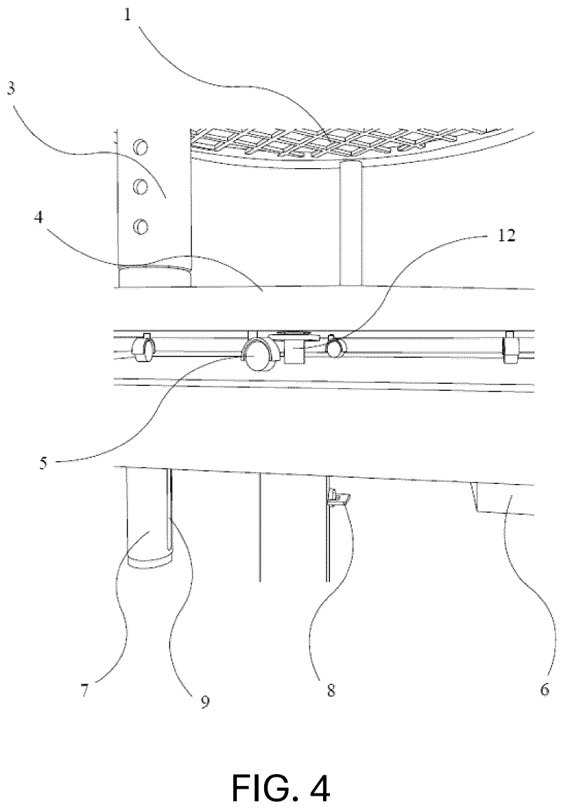

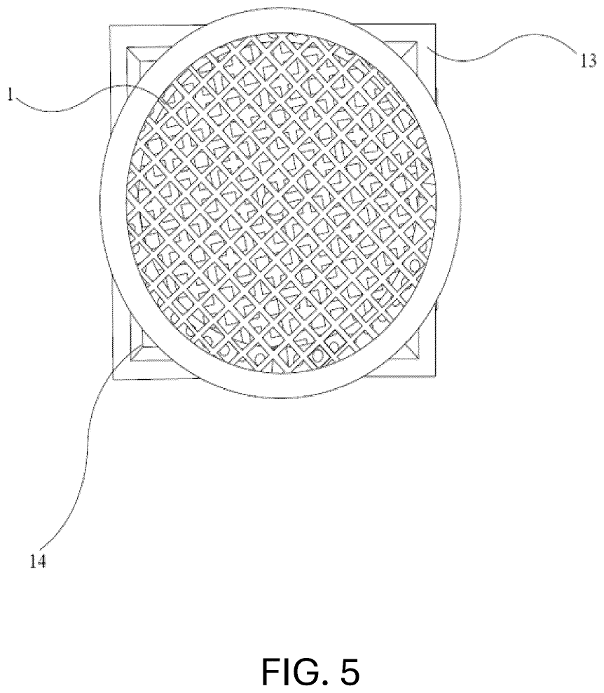

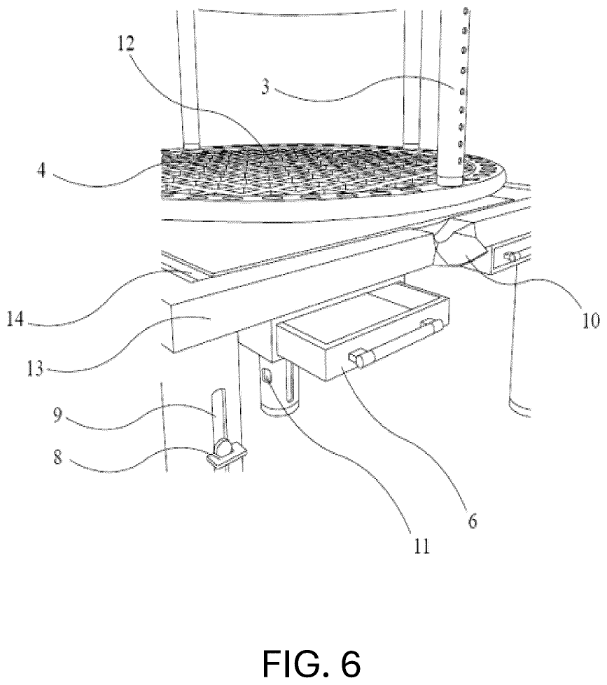

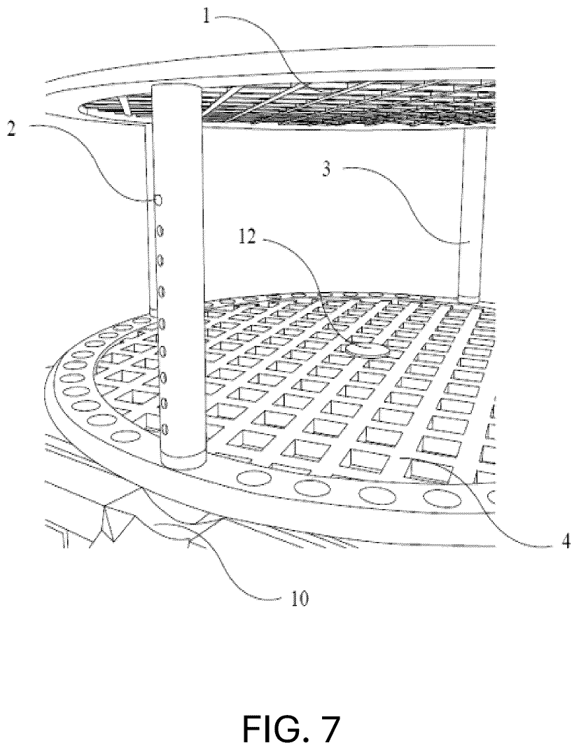

Referring to the drawings by numerals of reference there is shown in FIGS. 1-7, a plant care system comprising at least the following components: SCROG/upper netting 1 allows light stem training, stretching the branches out, creating an even canopy so light can hit more flower sites; spring loaded push button 2 allows the upper netting supports 3 to be adjusted to the user's desired height; upper netting support 3—supports the SCROG/upper netting 1; circular table 4 comprises perforated base for pots; casters 5 rotates the circular table 4; storage compartment 6 comprises small storage compartment; base leg 7 is adjustable supports for lower table 13; screw lock 8 locks and unlocks the screw lock cylinder inside the base leg in place; screw lock cylinder 9 allows the base leg to extend the height of the lazy jane lower table; drainage channel outlet 10 comprises a merged outlet for drainage channels on table; conduit port 11 allows power cords and watering hoses through the center of the present invention so it doesn't bind while spinning; center pole 12 is central axis that rotates the circular table 4; lower table 13 provides a level, smooth surface for rotation of circular table 4; channel 14 goes around the perimeter angled towards front drainage channel outlet 10.

Now, as such, in further detail, the plant care system comprises: a plant care assembly including a lower table 13 functioning as a base, the lower table 13 having a lower-table-top-surface, a drainage channel 10, and at least one leg (4 or 5 preferred, but more or less may be used), an upper table which is configured and indicated as a circular table 4 having an upper-table-top-surface, a thickness, and an under-table-top-surface, a coupler (coupling means) able to engage the lower table 13 and the upper table in functional combination such that the upper table of the plant care assembly such that it is able to rotate in relation to the lower table 13, (the upper table located on a plane above the lower table 13 during use), as shown. The coupler may comprise or be in combination with the center pole 12. The thickness of the upper table is defined between the upper-table-top-surface and the under-table-top-surface.

As designed, the plant care system is configured for use to elevate at least one host plant and such that the upper table is able to be rotated in relation to the lower table 13 such that the at least one host plant is able to be rotate-manipulated to a desired positioning for tending the at least one host plant. The at least one leg of the lower table 13 preferably comprises a plurality of the legs for increased stability. The legs are adjustable in relation to a ground surface via screw locks 8 and screw lock cylinders 9.

The upper table comprises a grid of apertures. The upper table preferably comprises an upper netting support 3 and an upper netting 1. The upper netting 1 allows light stem training as a canopy; wherein branches of the at least one host plant (multiple branches and host plants are possible) are able to be supported in a stretched positioning via connection to the canopy by any suitable means (ties, clips and the like). The upper netting 1 comprises a net-lattice; wherein the net-lattice comprises a grid, as shown. The grid comprises bars separating negative spaces and may be limited by a periphery along an inner and/or outer edge. The negative spaces allow light to pass through and the bars are able to serve for mounting the branches. The upper table comprises netting supports 3, as shown; wherein the netting supports 3 are adjustable between up and down positions in relation to the lower table 13. The lower table 13 of the plant care system preferably further comprises at least one conduit port 11 and at least one channel 14.

The plant care system of the present invention may further comprise a kit including: the plant care system assembly, and a set of user-instructions to facilitate use thereof.

A method of using a plant care system may comprise the steps of: providing the plant care system, setting at least one host plant on top of an upper table, and rotating the upper table in relation to a lower table to tend the at least one host plant in a desired positioning. The method may further comprise the step of supporting branches of the at least one host plant in a stretched positioning via connection to a canopy. Rotating and adjusting and other steps may be also employed as per the user's preference and best plant positioning.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A plant care system comprising:
a plant care assembly including;
a lower table functioning as a base, said lower table having
a lower-table-top-surface;
a drainage channel; and
at least one leg;
an upper table configured as a circular table having
an upper-table-top-surface;
a thickness; and
an under-table-top-surface;
a coupler able to engage said lower table and said upper table in functional combination such that said upper table of said plant care assembly is able to rotate in relation to said lower table, said upper table located on a plane above said lower table during use; and
wherein said thickness is defined between said upper-table-top-surface and said under-table-top-surface; and
wherein said plant care system is configured for use to elevate at least one host plant and such that said upper table is able to be rotated in relation to said lower table such that said at least one host plant is able to be rotate-manipulated to a desired positioning for tending said at least one host plant.

2. The plant care system of claim 1 wherein said at least one leg of said lower table comprises a plurality of said legs.

3. The plant care system of claim 2 wherein said legs are adjustable in relation to a ground surface.

4. The plant care system of claim 3 wherein said upper table comprises a grid of apertures.

5. The plant care system of claim 1 wherein said upper table comprises an upper netting support.

6. The plant care system of claim 5 wherein said upper table comprises an upper netting.

7. The plant care system of claim 6 wherein said upper netting allows light stem training as a canopy.

8. The plant care system of claim 7 wherein branches of said at least one host plant are able to be supported in a stretched positioning via connection to said canopy.

9. The plant care system of claim 8 wherein said upper netting comprises a net-lattice.

10. The plant care system of claim 9 wherein said net-lattice comprises a grid.

11. The plant care system of claim 10 wherein said grid comprises bars separating negative spaces.

12. The plant care system of claim 11 wherein said negative spaces allow light to pass through.

13. The plant care system of claim 12 wherein said upper table comprises netting supports.

14. The plant care system of claim 13 wherein said netting supports are adjustable between up and down positions in relation to said lower table.

15. The plant care system of claim 1 wherein said lower table further comprises at least one conduit port.

16. The plant care system of claim 15 wherein said lower table further comprises at least one channel.

17. A plant care system comprising:
a plant care assembly including;
a lower table functioning as a base, said lower table having
a lower-table-top-surface with at least one channel;
a drainage channel;
at least one leg; and
at least one conduit port;
an upper table configured as a circular table having
an upper-table-top-surface;
a thickness; and
an under-table-top-surface;
a coupler able to engage said lower table and said upper table in functional combination such that said upper table of said plant care assembly is able to rotate in relation to said lower table, said upper table located on a plane above said lower table during use; and
wherein said at least one leg of said lower table comprises four of said legs;
wherein said legs are adjustable in relation to a ground surface;
wherein said upper table comprises a grid of apertures;
wherein said upper table comprises an upper netting support;
wherein said upper table comprises an upper netting;
wherein said upper netting allows light stem training as a canopy;
wherein said upper netting comprises a net-lattice;
wherein said net-lattice comprises a grid;
wherein said grid comprises bars separating negative spaces;
wherein said negative spaces allow light to pass through;
wherein said upper table comprises netting supports;
wherein said netting supports are adjustable between up and down positions in relation to said lower table;
wherein said thickness is defined between said upper-table-top-surface and said under-table-top-surface; and
wherein said plant care system is configured for use to elevate at least one host plant and such that said upper table is able to be rotated in relation to said lower table such that said at least one host plant is able to be rotate-manipulated through 360 degrees to a desired positioning for tending said at least one host plant;
wherein branches of said at least one host plant are able to be supported in a stretched positioning via connection to said canopy.

18. The plant care system of claim 17 further comprising a kit including:
said plant care assembly; and
a set of user-instructions to facilitate use thereof.

19. A method of using a plant care system comprising the steps of:
providing said plant care system;
setting at least one host plant on top of an upper table; and
rotating said upper table in relation to a lower table to tend said at least one host plant in a desired positioning.

20. The method of claim 19 further comprising the step of supporting branches of said at least one host plant in a stretched positioning via connection to a canopy.
